(19) United States
(12) Patent Application Publication
(10) Pub. No.: US 2025/0372669 A1
(43) Pub. Date: Dec. 4, 2025

(54) THERMAL MANAGEMENT SYSTEM OF FUEL ELECTRIC VEHICLE AND CONTROL METHOD THEREOF

(71) Applicants: Hyundai Motor Company, Seoul (KR); Kia Corporation, Seoul (KR)

(72) Inventor: Jong Won Kim, Hwaseong-si (KR)

(21) Appl. No.: 18/908,342

(22) Filed: Oct. 7, 2024

(30) Foreign Application Priority Data
May 31, 2024 (KR) 10-2024-0071196

(51) Int. Cl. H01M 8/04007; B60H 1/00; H01M 8/04029; H01M 8/04119; H01M 8/10

(52) U.S. Cl. CPC H01M 8/04059; B60H 1/00278; B60H 1/00392; B60H 1/00921; H01M 8/04029; H01M 8/04141; B60H 2001/00307; B60H 2001/00928; H01M 2008/1095; H01M 2250/20

(57) ABSTRACT

A thermal management system for a fuel cell vehicle can include a compressor configured to compress refrigerant, a refrigerant-water heat exchanger provided to enable the compressor to suction the refrigerant therein, wherein the refrigerant-water heat exchanger has a first heat exchanger configured to perform heat exchange between the refrigerant and product water from a fuel cell discharge, an accumulator provided to enable the compressor to suction the refrigerant therein, wherein the accumulator has a second heat exchanger configured to perform heat exchange between the refrigerant and the product water, a flow control valve installed on a product water line configured to supply the product water, wherein the flow control valve controls an opening state thereof to selectively supply the product water to at least one of the first heat exchanger and the second heat exchanger, and a controller configured to control the opening state of the flow control valve.

### CROSS-REFERENCE TO RELATED APPLICATIONS

This application claims the benefit of Korean Patent Application No. 10-2024-0071196, filed on May 31, 2024, which application is hereby incorporated herein by reference.

### TECHNICAL FIELD

The present disclosure relates to a thermal management system for a fuel cell vehicle.

### BACKGROUND

A fuel cell system mounted in a fuel cell vehicle includes a fuel cell stack formed by stacking a plurality of fuel cells configured to generate electric energy through an electrochemical reaction between fuel gas and oxidizing gas, a fuel supply device configured to supply fuel gas (hydrogen) to the fuel cell stack, an air supply device configured to supply air containing oxygen, which is oxidizing gas, to the fuel cell stack, and a heat and water management system for temperature control and water management of the fuel cell stack

During operation of the fuel cell system, hydrogen is supplied to an anode of the fuel cell stack. Here, when air is supplied to a cathode of the fuel cell stack, an oxidation reaction of hydrogen proceeds at the anode, thereby generating hydrogen ions and electrons. Thereafter, hydrogen ions and electrons generated as described above move to the cathode through a polymer electrolyte membrane and a separator plate of the fuel cell stack, respectively.

In this case, an electrochemical reaction involving hydrogen ions and electrons transferred from the anode and oxygen in the air occurs at the cathode, and water is produced by the electrochemical reaction, and simultaneously, electrical energy is generated from a flow of electrons.

Meanwhile, to respond to cooling and heating load continuously required by a fuel cell vehicle having a fuel cell system mounted therein and to increase driving range, it is necessary to provide a method of utilizing a heat transfer process of product water discharged from a thermal management-related refrigerant cycle system and a fuel cell stack in a complex manner.

In fuel cells, a certain amount of water (hereinafter referred to as “product water”) is incidentally generated. Here, the amount of water is larger than an amount of fuel used to generate electric energy. Meanwhile, in a typical fuel cell vehicle, the “product water” generated as a reaction by-product in the electrochemical reaction is not recycled and is discharged to the outside of a vehicle. In addition, thermal energy contained in the product water is not utilized and is simply discarded.

Furthermore, a thermal management system provided in a fuel cell vehicle including a cooling and heating system and a heat pump system has a problem in that heating performance deteriorates in a low temperature region (for example, −10° C.) due to negative pressure formation caused by an insufficient heat source.

To solve the above-described problems, a gas injection heat pump is employed, but there is a limit to improvement in cycle efficiency because gaseous refrigerant is used through two-stage expansion without a separate heat source.

The above information disclosed in this Background section is only for enhancement of understanding of the background of the present disclosure, and therefore it may contain information that does not form the prior art that is already publicly known, available, or in use.

### SUMMARY

The present disclosure relates to a thermal management system for a fuel cell vehicle configured to use, for vehicle air conditioning, thermal energy of product water generated as a reaction by-product of a fuel cell, and a control method thereof.

An embodiment of the present disclosure can solve the above-described problems associated with the prior art, and can provide a thermal management system configured not only to use, as an energy source, “product water” generated as a reaction by-product of a fuel cell in a fuel cell vehicle, but also to use, for vehicle air conditioning, thermal energy of the product water generated by the fuel cell, and a control method of the thermal management system.

The advantages provided by embodiments of the present disclosure are not necessarily limited to the above-mentioned advantage, and other technical advantages not mentioned herein can be understood by those skilled in the art to which the present disclosure pertains (referred to hereinafter as “those skilled in the art”) from the detailed description of the example embodiments.

An embodiment of the present disclosure can provide a thermal management system for a fuel cell vehicle, and the thermal management system can include a compressor configured to compress refrigerant, a refrigerant-water heat exchanger provided to enable the compressor to suction the refrigerant therein, where the refrigerant-water heat exchanger has a first heat exchanger provided therein and configured to perform heat exchange between the refrigerant and product water generated by a fuel cell and discharged from a fuel cell stack, an accumulator provided to enable the compressor to suction the refrigerant therein, where the accumulator has a second heat exchanger provided therein and configured to perform heat exchange between the refrigerant and the product water generated by the fuel cell, a flow control valve installed on a product water line configured to supply the product water generated by the fuel cell and discharged from the fuel cell stack, where the flow control valve controls an opening state thereof so as to selectively supply the product water generated by the fuel cell to at least one of the first heat exchanger and the second heat exchanger, and a controller configured to control the opening state of the flow control valve.

An embodiment of the present disclosure can provide a control method of a thermal management system for a fuel cell vehicle, and the thermal management system can include a refrigerant-water heat exchanger provided to enable a compressor to suction refrigerant therein, where the refrigerant-water heat exchanger has a first heat exchanger provided therein and configured to perform heat exchange between the refrigerant and product water generated by a fuel cell and discharged from a fuel cell stack, an accumulator configured to store the refrigerant passing through an evaporator and to enable the compressor to suction the refrigerant stored therein, where the accumulator has a second heat exchanger provided therein and configured to perform heat exchange between the refrigerant and the product water generated by the fuel cell, and a flow control valve installed on a product water line configured to supply the product water generated by the fuel cell and discharged from the fuel cell stack, where the flow control valve controls an opening state thereof so as to selectively supply the product water generated by the fuel cell to at least one of the first heat exchanger and the second heat exchanger, where the opening state of the flow control valve is controlled depending on a cooling mode and a heating mode by a controller, thereby selectively supplying the product water generated by the fuel cell to at least one of the first heat exchanger and the second heat exchanger.

In an embodiment of the present disclosure, a thermal management system may further include an outdoor heat exchanger configured to perform heat exchange between the refrigerant and air, and the first heat exchanger may be configured to perform the heat exchange between the refrigerant passing through the outdoor heat exchanger and the product water generated by the fuel cell.

In an embodiment of the present disclosure, a thermal management system may further include an indoor heat exchanger configured to perform heat exchange between the refrigerant compressed by the compressor and air-conditioning air, a first expansion valve configured to selectively expand the refrigerant passing through the indoor heat exchanger so as to supply the refrigerant to the outdoor heat exchanger, a second expansion valve configured to expand the refrigerant discharged from the refrigerant-water heat exchanger, and an evaporator configured to perform heat exchange between the refrigerant passing through the second expansion valve and the air-conditioning air, where the second heat exchanger may be configured to perform the heat exchange between the refrigerant passing through the evaporator and the product water generated by the fuel cell.

In an embodiment of the present disclosure, a controller may be configured to control, in the heating mode, the opening state of the flow control valve, thereby supplying the product water generated by the fuel cell to the first heat exchanger of the refrigerant-water heat exchanger and performing the heat exchange between the refrigerant in the refrigerant-water heat exchanger and the product water generated by the fuel cell.

In an embodiment of the present disclosure, a controller may be configured to control, in the heating mode, the opening state of the flow control valve, thereby supplying the product water generated by the fuel cell to the second heat exchanger of the accumulator and performing the heat exchange between the refrigerant in the accumulator and the product water generated by the fuel cell.

In an embodiment of the present disclosure, a controller may be configured to control, in the heating mode, the opening state of the flow control valve, thereby simultaneously supplying and distributing the product water generated by the fuel cell to the first heat exchanger of the refrigerant-water heat exchanger and the second heat exchanger of the accumulator and performing the heat exchange between the refrigerant in the refrigerant-water heat exchanger and the accumulator and the product water generated by the fuel cell.

In an embodiment of the present disclosure, a controller may be configured to control, in the cooling mode, the opening state of the flow control valve, thereby supplying the product water generated by the fuel cell to the first heat exchanger of the refrigerant-water heat exchanger and performing the heat exchange between the refrigerant in the refrigerant-water heat exchanger and the product water generated by the fuel cell.

In an embodiment of the present disclosure, a product water line in a thermal management system may branch into two branch lines respectively connected to the first heat exchanger and the second heat exchanger, and the flow control valve in the thermal management system may be installed at a location at which the product water line branches into the two branch lines.

In an embodiment of the present disclosure, a refrigerant-water heat exchanger in a thermal management system may be a flash tank configured to separate gaseous refrigerant from liquid refrigerant therein, where the flash tank may be configured to supply the gaseous refrigerant to the compressor and to supply the liquid refrigerant to an expansion valve.

It can be understood that the terms “vehicle”, “vehicular”, and other similar terms as used herein can be inclusive of motor vehicles in general, such as passenger automobiles including sport utility vehicles (SUV), buses, trucks, various commercial vehicles, tractors, agricultural equipment, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum), for example. As referred to herein, a hybrid vehicle can be a vehicle that has two or more sources of power, for example, vehicles powered by both gasoline and electricity.

### BRIEF DESCRIPTION OF THE DRAWINGS

The above and other features of embodiments of the present disclosure will now be described in detail with reference to certain example embodiments thereof illustrated in the accompanying drawings, which are given hereinbelow by way of illustration only, and thus are not necessarily limitative of the present disclosure, and in which:

FIG. 1 is a circuit diagram showing a thermal management system of a gas injection type according to an embodiment of the present disclosure;

FIG. 2 is a block diagram showing a control element and an operating element in a thermal management system according to an embodiment of the present disclosure;

FIG. 3 is a flowchart showing a control process of a thermal management system according to an embodiment of the present disclosure;

FIG. 4 is a diagram showing an operating state in a heating mode of a thermal management system according to an embodiment of the present disclosure;

FIG. 5 is a P-H diagram showing a suction pressure rise of a single-stage cycle in the heating mode of FIG. 4;

FIG. 6 is a diagram showing an operating state in a heating mode of a thermal management system according to an embodiment of the present disclosure;

FIG. 7 is a P-H diagram showing an increase in suction pressure of a two-stage cycle in the heating mode of FIG. 6;

FIG. 8 is a diagram showing an operating state in a heating mode of a thermal management system according to an embodiment of the present disclosure;

FIG. 9 is a P-H diagram showing the control and rise of suction pressure in the single-stage cycle and the two-stage cycle in the heating mode of FIG. 8;

FIG. 10 is a diagram showing an operating state in a cooling mode of a thermal management system according to an embodiment of the present disclosure; and

FIG. 11 is a P-H diagram showing a decrease in system pressure in the cooling mode of FIG. 10.

It can be understood that the appended drawings are not necessarily to scale, presenting a somewhat simplified representation of various features illustrative of the principles of the present disclosure. The specific design features of example embodiments of the present disclosure as disclosed herein, including, for example, specific dimensions, orientations, locations, and shapes will be determined in part by the particular intended application and use environment.

In the figures, reference numbers can refer to same or equivalent parts of embodiments of the present disclosure throughout the several figures of the drawing.

### DETAILED DESCRIPTION OF ILLUSTRATIVE EMBODIMENTS

Hereinafter, example embodiments of the present disclosure will be described in detail with reference to the attached drawings. Specific structural or functional descriptions given in connection with the example embodiments of the present disclosure can be merely illustrative for the purpose of describing embodiments according to concepts of the present disclosure, and the example embodiments according to the concept of the present disclosure may be implemented in various forms. Further, it can be understood that the present description is not intended to necessarily limit the disclosure to the example embodiments. On the contrary, the disclosure can cover not only the example embodiments, but also various alternatives, modifications, equivalents, and other embodiments, which may be included within the spirit and scopes of the disclosure as defined by the appended claims.

In the present disclosure, terms such as “first” and/or “second” may be used to describe various components, but the components are not necessarily limited by such terms. Such terms can be used merely for the purpose of distinguishing one component from other components. For example, a first component may be referred to as a second component, and similarly, a second component may also be referred to as a first component without departing from the scopes of rights according to concepts of the present disclosure.

When one component is referred to as being “connected” or “joined” to another component, the one component may be directly connected or joined to the other component, but it can be understood that other components may be present therebetween. On the other hand, when the one component is referred to as being “directly connected to” or “directly in contact with” the other component, it can be understood that other components are not present therebetween. Other expressions for the description of relationships between components, such as “between” and “directly between” or “adjacent to” and “directly adjacent to”, can be interpreted in the same or similar manner.

Same reference numerals can represent the same components throughout the specification. Additionally, the terms in the specification can be used merely to describe example embodiments and are not intended to necessarily limit the present disclosure. In this specification, an expression in a singular form also can include a plural form, unless clearly specified otherwise in context. As used herein, expressions such as “comprise” and/or “comprising” do not exclude the presence or addition of one or more components, steps, operations, and/or elements other than those described.

An embodiment of the present disclosure can provide a method of using, as an energy source, product water (by-product water) generated as a by-product of an electrochemical reaction in a fuel cell stack of a fuel cell vehicle.

More specifically, an embodiment of the present disclosure can provide a method of using, for vehicle air conditioning, thermal energy of product water generated by a fuel cell in a fuel cell vehicle equipped with a thermal management system including a gas injection heat pump.

Further, in an embodiment of the present disclosure, product water generated by a fuel cell and discarded to the outside of a vehicle can be used as a heat source in a thermal management system of a fuel cell vehicle, thereby controlling refrigerant pressure of the thermal management system and improving efficiency thereof.

A gas injection heat pump can be a system configured to use a heat exchanger or a flash tank so as to increase a flow rate of circulating refrigerant during heating, thereby having an effect of improving heating efficiency of a vehicle.

An embodiment of the present disclosure may be applied to a fuel cell vehicle equipped with a thermal management system of a gas injection type including a flash tank, and to control pressure of a low pressure portion of the thermal management system by controlling a heat absorption amount between liquid refrigerant inside the flash tank and an accumulator and product water generated by a fuel cell, thereby improving efficiency of the thermal management system.

Hereinafter, example embodiments of the present disclosure will be described in more detail.

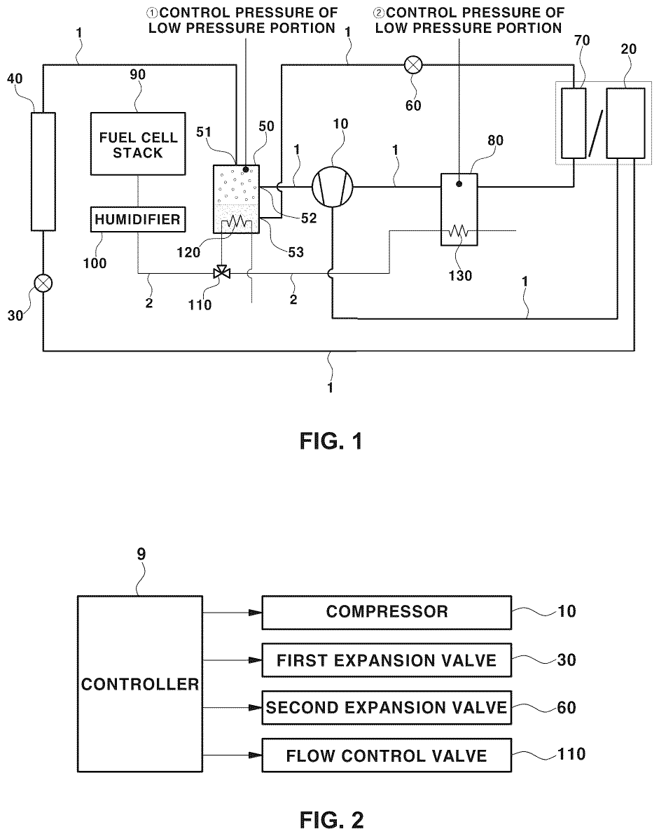

FIG. 1 is a circuit diagram showing a thermal management system of a gas injection type according to an embodiment of the present disclosure. FIG. 2 is a block diagram showing a control element and an operating element in a thermal management system according to an embodiment of the present disclosure. In the illustrated thermal management system, a low pressure portion may be referred to as the interior of a flash tank and the interior of an accumulator in which refrigerant exists in a low pressure state.

As shown in the drawing, the thermal management system in a fuel cell vehicle can include a heating and cooling system that performs cooling, heating, and air conditioning in the vehicle interior, and the cooling and heating system can include a refrigerant circuit.

The refrigerant circuit can include a compressor 10, an indoor heat exchanger 20, a first expansion valve 30, an outdoor heat exchanger 40, a flash tank 50, a second expansion valve 60, an evaporator 70, and an accumulator 80, any combination of or all of which may be in plural or may include plural components thereof. The components of the refrigerant circuits can be connected to each other through a refrigerant line 1 so that refrigerant may circulate through the components in turn.

The compressor 10 of the refrigerant circuit can compress refrigerant in a high temperature and high pressure state in a refrigerant circulation path and deliver the compressed refrigerant. The indoor heat exchanger 20 can receive the refrigerant compressed by the compressor 10 to perform heat exchange between the refrigerant and air. Then, the indoor heat exchanger 20 can cause the refrigerant to condense during a heat exchange process.

The indoor heat exchanger 20 functioning as a condenser can be also referred to as an “internal condenser”. The indoor heat exchanger 20 and the evaporator 70 can be located on/in an air passage in an air-conditioning case. Accordingly, air-conditioning air blown by an air-conditioning blower (not shown) may selectively pass through the evaporator 70 and the indoor heat exchanger 20 while flowing along the air passage in the air-conditioning case.

High-temperature and high-pressure refrigerant supplied from the compressor 10 can pass through the interior of the indoor heat exchanger 20, and air-conditioning air blown by the air-conditioning blower can pass through the periphery of the indoor heat exchanger 20.

Accordingly, heat exchange between refrigerant and air may be performed in the indoor heat exchanger 20, and during heat exchange, air-conditioning air can be heated by the refrigerant supplied from the compressor 10 and then can be supplied to the vehicle interior, thereby heating the vehicle interior.

The first expansion valve 30 can expand the refrigerant supplied through the refrigerant line 1 after passing through the indoor heat exchanger 20 to a low-temperature and low-pressure state. The first expansion valve 30 may be an electronic expansion valve controlled to selectively expand refrigerant by a controller.

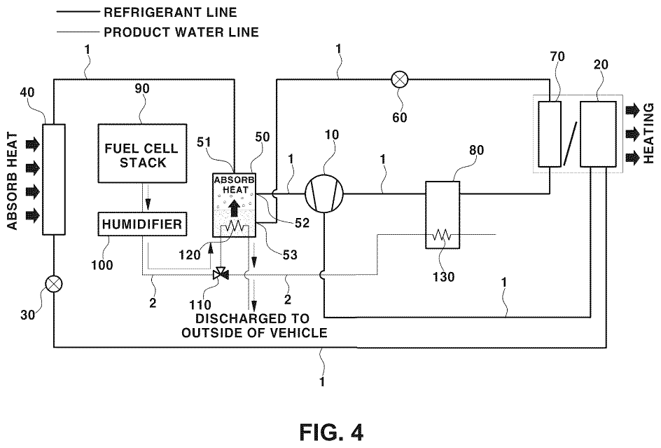

The outdoor heat exchanger 40 can enable heat exchange between the refrigerant and air (outside air). While the low-temperature and low-pressure refrigerant expanded by the first expansion valve 30 passes through the outdoor heat exchanger 40, the refrigerant may absorb heat from the air in the outdoor heat exchanger 40, thereby performing refrigerant heat absorption to be described later (refer to the heating mode in FIGS. 4, 6, and 8 to be described later).

On the other hand, in the cooling mode, when the refrigerant that has passed through the first expansion valve 30 passes through the outdoor heat exchanger 40 in a state in which the first expansion valve 30 is controlled to be fully opened or a flow rate of the expanded refrigerant is controlled, heat of the refrigerant can be discharged to the air (outside air) in the outdoor heat exchanger 40, thereby performing refrigerant heat dissipation (the refrigerant condenses).

In this manner, the outdoor heat exchanger 40 functioning as a condenser in the cooling mode can be also referred to as an “external condenser”. The outdoor heat exchanger 40 can be positioned so as to allow outside air suctioned by a cooling fan (not shown) to pass therethrough. Accordingly, while the outside air suctioned by the cooling fan passes through the periphery of the outdoor heat exchanger 40, heat exchange may be performed between the refrigerant passing through the interior of the outdoor heat exchanger 40 and the outside air passing through the periphery thereof.

The flash tank 50 can be connected to the outdoor heat exchanger 40 through the refrigerant line 1 and can be capable of receiving refrigerant that has passed through the outdoor heat exchanger 40. An inlet 51 of the flash tank 50 can be connected to an outlet of the outdoor heat exchanger 40 via the refrigerant line 1.

In addition, in the flash tank 50, gas-liquid separation of the refrigerant supplied thereinto can be performed. The flash tank 50 can have a first outlet 52 configured to allow gaseous refrigerant to be discharged therethrough and a second outlet 53 configured to allow liquid refrigerant to be discharged therethrough.

The first outlet 52 may be installed at an upper portion of the flash tank 50, and the second outlet 53 may be installed at a lower portion of the flash tank 50. The first outlet 52 can be connected to an inlet of the compressor 10 via the refrigerant line 1, and the second outlet 53 can be connected to an inlet of the second expansion valve 60 via the refrigerant line 1.

Accordingly, only the gaseous refrigerant separated through the gas-liquid separation may be suctioned into the compressor 10 through the first outlet 52 and the refrigerant line 1, and only the liquid refrigerant may flow to the second expansion valve 60 through the second outlet 53 and the refrigerant line 1.

The second expansion valve 60 can receive refrigerant discharged from the flash tank 50, expand the refrigerant to a low-temperature and low-pressure state, and supply the expanded refrigerant to the evaporator 70 via the refrigerant line 1. The second expansion valve 60 may be an electronic expansion valve controlled to selectively expand the refrigerant by a controller.

In this manner, the refrigerant supplied from the second expansion valve 60 can pass through the interior of the evaporator 70. Air-conditioning air blown by the air-conditioning blower can pass through the periphery of the evaporator 70.

Accordingly, in the evaporator 70, heat exchange may be performed between the low-temperature and low-pressure refrigerant expanded by the second expansion valve 60 and the air-conditioning air, and the air-conditioning air cooled by heat exchange with the refrigerant in the evaporator 70 can be discharged into the vehicle interior, thereby cooling the vehicle interior.

An outlet of the evaporator 70 can be connected to an inlet of the accumulator 80 via the refrigerant line 1, and an outlet of the accumulator 80 can be connected to the inlet of the compressor 10 via the refrigerant line 1. In this case, the inlet through which the refrigerant flows and the outlet through which the refrigerant is discharged may be installed at the upper portion of the accumulator 80.

The accumulator 80 can be installed on the refrigerant line 1 at an upstream (front) position of the compressor 10 relative to a path through which the refrigerant circulates, that is, installed on the refrigerant line 1 between the evaporator 70 and the compressor 10. In this manner, the accumulator 80 can allow only gaseous refrigerant to be supplied to the compressor 10 through gas-liquid separation, thereby improving efficiency and durability of the compressor 10.

In an embodiment of the present disclosure, a product water line 2 extending from the fuel cell system can be connected to each of the flash tank 50 and the accumulator 80 so that “product water” generated as a by-product of an electrochemical reaction in a fuel cell stack 90 may be selectively supplied to the flash tank 50 and the accumulator 80.

The product water line 2 can be connected from a portion at which the product water is discharged from the fuel cell system to each of the flash tank 50 and the accumulator 80. In the fuel cell system, the product water line 2 may be connected from the fuel cell stack 90 configured to generate product water by an electrochemical reaction and to discharge the product water therefrom to each of the flash tank 50 and the accumulator 80.

Specifically, the product water line 2 may be connected to the anode side of the fuel cell stack 90, and a humidifier 100 configured to humidify air supplied to the fuel cell stack 90 may be installed in the middle of the product water line 2.

Accordingly, the product water discharged from the anode side of the fuel cell stack 90 can humidify the air supplied to the fuel cell stack while passing through the humidifier 100, and then the remaining product water that has passed through the humidifier 100 can move along the product water line 2 and can be supplied to the flash tank 50 and the accumulator 80.

The product water line 2 can be connected to the outlet side of the humidifier 100 and can be branched into two branch lines. One branch line of the product water line 2 can be connected to the flash tank 50, and the other branch line thereof can be connected to the accumulator 80. One branch line of the product water line 2 may be connected to a first heat exchanger 120 located on the lower side of the flash tank 50, and the other branch line thereof may be connected to a second heat exchanger 130 located on the lower side of the accumulator 80.

Accordingly, the product water discharged from the fuel cell stack 90 may flow along the product water line 2, may pass through the first heat exchanger 120 of the flash tank 50, and then may be discharged to the outside of the vehicle. Alternatively or also, the product water discharged from the fuel cell stack 90 may flow along the product water line 2, may pass through the second heat exchanger 130 of the accumulator 80, and then may be discharged to the outside of the vehicle.

In addition, a flow control valve 110 can be installed at a branch point at which the product water line 2 branches into two branch lines, in which the flow control valve 110 controls the supply and flow of product water to each of the first heat exchanger 120 and the second heat exchanger 130. The flow control valve 110 may be an electronic 3-way valve, the opening state of which can be controlled by a controller.

As a result, the opening state of the flow control valve 110 may be controlled in various ways by the controller. The controller may control the opening state of the flow control valve 110 so that the entire amount of product water flows only to the first heat exchanger 120 inside the flash tank 50.

Alternatively, the controller may control the opening state of the flow control valve 110 so that the entire amount of product water flows only to the second heat exchanger 130 inside the accumulator 80. Alternatively, the controller may control the opening state of the flow control valve 110 so that the product water is distributed and introduced into each of the first heat exchanger 120 and the second heat exchanger 130.

While the product water generated and discharged from the fuel cell stack 90 passes through the first heat exchanger 120 inside the flash tank 50, thermal energy of the product water may be transferred to the refrigerant inside the flash tank 50, thereby making it possible to control pressure inside the flash tank 50, which can be a low pressure area.

Alternatively, heat may be transferred from the refrigerant inside the flash tank 50 to the product water passing through the first heat exchanger 120. As described above, in the present disclosure, the flash tank 50 can function as a refrigerant-water heat exchanger in which heat exchange occurs between refrigerant and water (product water).

Similarly, while the product water generated and discharged from the fuel cell stack 90 passes through the second heat exchanger 130 inside the accumulator 80, thermal energy of the product water may be transferred to the refrigerant inside the accumulator 80, thereby making it possible to adjust pressure inside the accumulator 80, which can be a low pressure area.

In an embodiment of the present disclosure, the product water that has been discharged from the fuel cell stack 90 and then has passed through the humidifier 100 may be supplied only to the flash tank 50, only to the accumulator 80, or to both the flash tank 50 and the accumulator 80. Accordingly, pressure of a low pressure portion may be adjusted by allowing thermal energy of the product water to be transferred to the refrigerant.

In an embodiment of the present disclosure, refrigerant pressure inside the flash tank 50 and the accumulator 80, which can be low pressure portions of the thermal management system, may be adjusted depending on the opening state of the flow control valve 110. In this manner, the flow control valve 110 can serve as a pressure control valve configured not only to control a flow direction and a flow rate of refrigerant, but also to control pressure of a low pressure portion.

Accordingly, in an embodiment of the present disclosure, thermal energy of the product water generated by a fuel cell and discarded to the outside of a vehicle may be used to control refrigerant pressure of a heat management system, and in particular, may be used to control pressure of a low pressure portion. As a result, using an embodiment of the present disclosure, it becomes possible to secure performance of a gas injection heat pump in a low temperature area. In addition, using an embodiment of the present disclosure, it becomes possible to control system efficiency by adjusting the pressure of the low pressure portion.

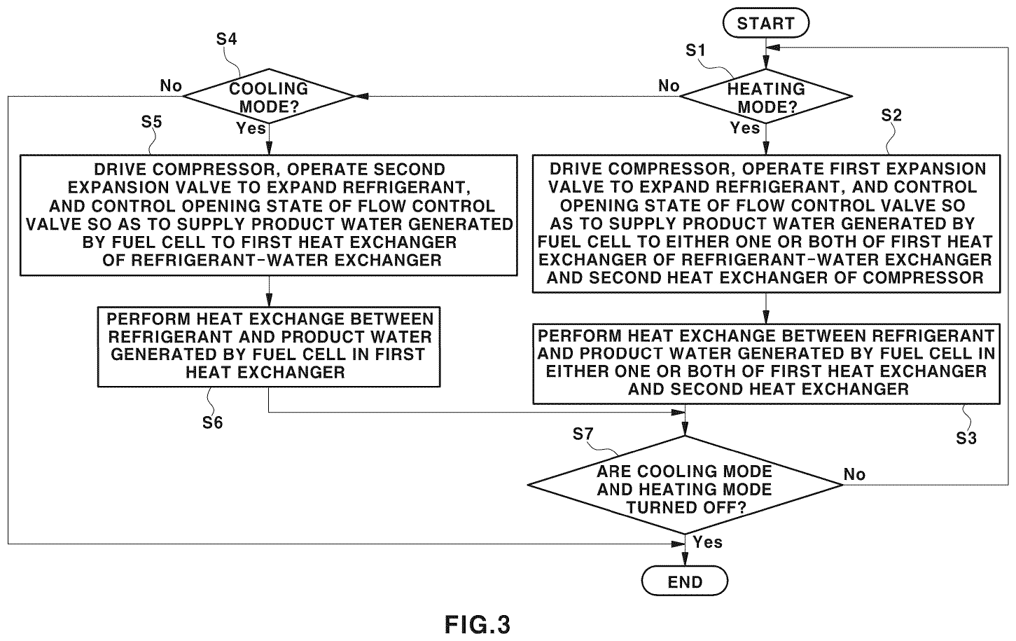

FIG. 3 is a flowchart showing a control process of a thermal management system according to an embodiment of the present disclosure. FIG. 4 is a diagram showing an operating state of a thermal management system according to an embodiment of the present disclosure. Specifically, FIG. 4 shows an operating state of a heating mode in which product water generated by a fuel cell is supplied to the first heat exchanger 120 of the flash tank 50, in which the first heat exchanger 120 serves as a refrigerant-water heat exchanger.

In the case of heating mode in step S1 of FIG. 3, the compressor 10 can be driven (refer to step S2), and gaseous refrigerant inside the flash tank 50 and the accumulator 80 can be suctioned by the compressor 10. Thereafter, the gaseous refrigerant can be compressed to high temperature and high pressure and then discharged. The discharged refrigerant can flow along the refrigerant line 1 and can be supplied to the indoor heat exchanger 20 serving as an internal condenser.

The high-temperature and high-pressure refrigerant supplied to the indoor heat exchanger 20 can exchange heat with air-conditioning air passing through the periphery of the indoor heat exchanger 20 while passing through the interior of the indoor heat exchanger 20. While heat of the refrigerant is transferred to the air-conditioning air, the refrigerant can be condensed, and the air-conditioning air can be heated. In this manner, the air-conditioning air heated by the refrigerant can be discharged into the vehicle interior, thereby heating the vehicle interior.

The refrigerant that has passed through the indoor heat exchanger 20 can expand to a low-temperature and low-pressure state while passing through the first expansion valve 30 (refer to step S2), and the refrigerant in the low-temperature and low-pressure state, which has expanded in the first expansion valve 30, can be supplied to the outdoor heat exchanger 40.

The refrigerant in the low-temperature and low-pressure state, which has been supplied to the outdoor heat exchanger 40, can perform heat exchange by absorbing heat from outside air passing through the periphery of the outdoor heat exchanger 40 while passing through the interior of the outdoor heat exchanger 40. During heat exchange, heat from the outside air can be transferred to the refrigerant, and the temperature of the refrigerant can rise.

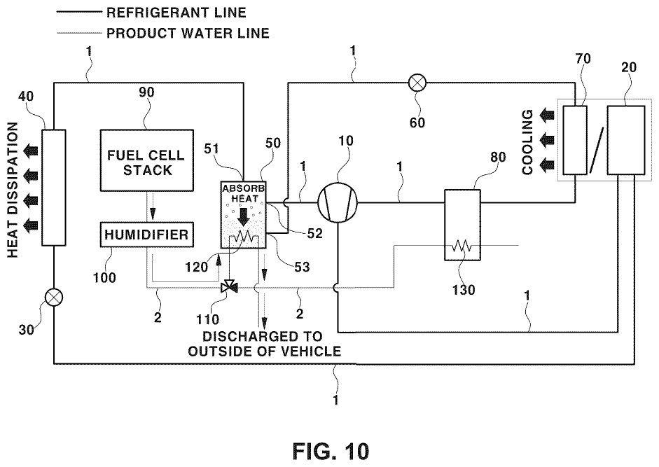

In this manner, in the heating mode, the outdoor heat exchanger 40 can serve as the evaporator 70. For reference, in the cooling mode, the outdoor heat exchanger 40 can serve as an external condenser that condenses refrigerant using outside air (e.g., refer to FIG. 10).

The refrigerant that has undergone heat absorption in the outdoor heat exchanger 40 can flow along the refrigerant line 1 and can be supplied into the flash tank 50. The opening state of the flow control valve 110 can be controlled by the controller so that the entire amount of product water discharged from the fuel cell stack 90 can be supplied to the first heat exchanger 120 of the flash tank 50 (refer to step S2).

As a result, the refrigerant in the flash tank 50 can receive thermal energy of the product water that has been discharged from the fuel cell stack 90 and then has passed through the interior of the first heat exchanger 120 (can perform heat exchange between the refrigerant and the product water generated by the fuel cell, refer to step S3). The refrigerant can absorb heat from the product water serving as a heat source, thereby increasing the temperature of the refrigerant and refrigerant pressure inside the flash tank.

In this manner, in an embodiment of the present disclosure, the pressure inside the flash tank, which can be one of the low pressure portions of the heat management system, may be increased, and pressure control in the low pressure portion may be performed through heat absorption of the refrigerant that absorbs the thermal energy of the product water.

The product water that has passed through the first heat exchanger 120 of the flash tank 50 can be discharged to the outside of the vehicle, and the gaseous refrigerant in the flash tank 50 can be suctioned into the compressor 10 through the first outlet 52 in a state in which the pressure of the gaseous refrigerant is increased (e.g., low pressure to medium pressure) and then can flow along the refrigerant line 1 so as to recirculate the refrigerant circuit.

The liquid refrigerant in the flash tank 50 can be discharged into the refrigerant line 1 through the second outlet 53 and can flow to the second expansion valve 60. After passing through the second expansion valve 60, the liquid refrigerant can flow to the accumulator 80 through the evaporator 70. Then, the refrigerant can be suctioned from the accumulator 80 into the compressor 10 and then can flow along the refrigerant line 1 so as to recirculate the refrigerant circuit. Afterwards, when the heating mode is turned off (refer to step S7), the above-mentioned control process can be completed.

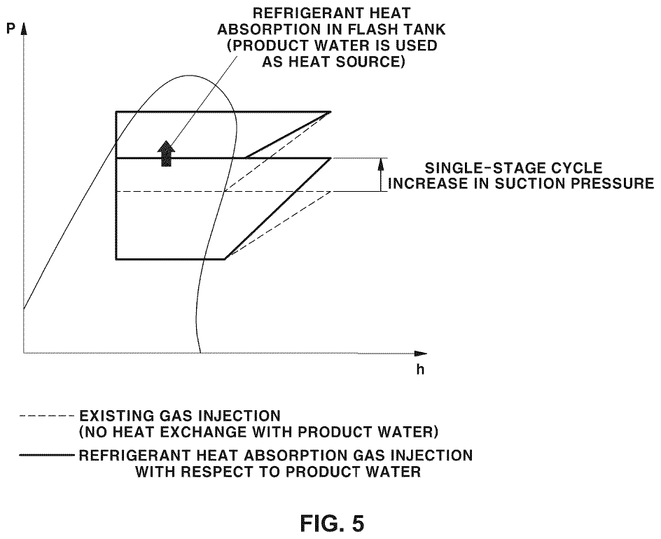

FIG. 5 is a P-H diagram showing an increase in suction pressure of a single-stage cycle in the heating mode of FIG. 4. In FIG. 5, a dotted line represents a conventional gas injection state, and a solid line represents a refrigerant heat absorption gas injection state of the present disclosure.

As described above, as the refrigerant absorbs heat from the product water inside the flash tank 50, the pressure inside the flash tank, which can be a low pressure portion, can increase, thereby can have an effect of increasing suction pressure (compressor suction pressure) of the single-stage cycle.

More specifically, when a gas injection heat pump is applied to the thermal management system so as to improve heating performance and efficiency in a fuel cell vehicle, in the related art, an outdoor heat exchanger, which is an external condenser, allows the refrigerant to absorb heat from the outside air for the operation of the heat pump, but there can be a limit to heating performance of the heat pump due to an insufficient heat source.

On the other hand, in an embodiment of the present disclosure, the product water generated in the fuel cell stack 90 can be supplied to the flash tank 50 through the flow control valve 110 operating and functioning as a pressure control valve.

In this example case, thermal energy of the product water may be supplied to the refrigerant in the flash tank 50, and refrigerant heat absorption may be performed in the flash tank 50. As a result, in an embodiment of the present disclosure, it can be possible to increase the pressure of the gaseous refrigerant injected into the compressor 10 after primary expansion by the first expansion valve 30.

As a result, in an embodiment of the present disclosure, efficiency of the compressor 10 may be improved, and suction pressure at a low pressure portion formed after the singe-stage expansion of the refrigerant may increase, thereby also improving power consumption efficiency of the compressor.

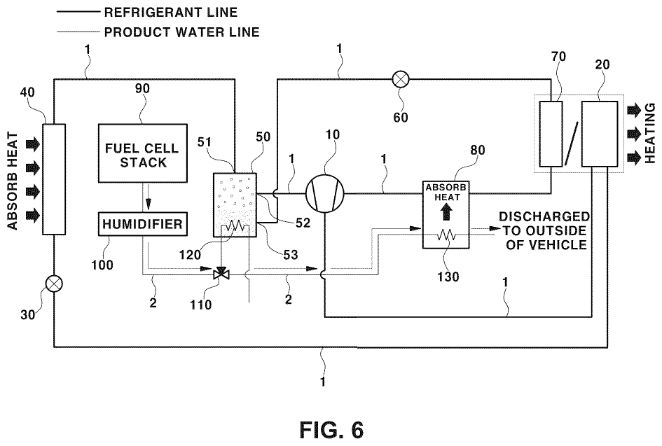

FIG. 6 is a diagram showing another operating state of the thermal management system according to an embodiment of the present disclosure. Specifically, FIG. 6 shows the operating state of a heating mode in which product water generated by a fuel cell is supplied to the second heat exchanger 130 of the accumulator 80.

As shown in the drawing, in the case of the heating mode in step S1 of FIG. 3, the compressor 10 can be driven (refer to step S2), and gaseous refrigerant inside the flash tank 50 and the accumulator 80 can be suctioned by the compressor 10. Thereafter, the gaseous refrigerant can be compressed to high temperature and high pressure and then can be discharged. In this case, the discharged refrigerant can flow along the refrigerant line 1 and can be supplied to the indoor heat exchanger 20 serving as an internal condenser.

The high-temperature and high-pressure refrigerant supplied to the indoor heat exchanger 20 can exchange heat with air-conditioning air passing through the periphery of the indoor heat exchanger 20 while passing through the interior of the indoor heat exchanger 20. In this case, while heat of the refrigerant is transferred to the air-conditioning air, the refrigerant can be condensed, and the air-conditioning air can be heated. In this manner, the air-conditioning air heated by the refrigerant can be discharged into the vehicle interior, thereby heating the vehicle interior.

The refrigerant that has passed through the indoor heat exchanger 20 can expand to a low-temperature and low-pressure state while passing through the first expansion valve 30 (refer to step S2), and the low-temperature and low-pressure refrigerant expanded by the first expansion valve 30 can be supplied to the outdoor heat exchanger 40.

The low-temperature and low-pressure refrigerant supplied to the outdoor heat exchanger 40 can perform heat exchange by absorbing heat from outside air passing through the periphery of the outdoor heat exchanger 40 while passing through the interior of the outdoor heat exchanger 40. During heat exchange, the heat from the outside air can be transferred to the refrigerant, and the temperature of the refrigerant can rise.

The refrigerant that has undergone heat absorption in the outdoor heat exchanger 40 can flow along the refrigerant line 1 and can be supplied into the flash tank 50. In this case, the opening state of the flow control valve 110 can be controlled by a controller so that the entire amount of product water discharged from the fuel cell stack 90 can be supplied to the accumulator 80.

Accordingly in such case, heat exchange between the refrigerant and the product water is not performed in the flash tank 50. The gaseous refrigerant in the flash tank 50 can be suctioned into the compressor 10 through the first outlet 52 in a low pressure state without pressure change, and then can flow along the refrigerant line 1 so as to recirculate the refrigerant circuit.

In this case, the liquid refrigerant in the flash tank 50 can be discharged into the refrigerant line 1 through the second outlet 53 and then can flow to the second expansion valve 60. Then, after passing through the second expansion valve 60, the liquid refrigerant flows to the accumulator 80 through the evaporator 70. Simultaneously, the opening state of the flow control valve 110 is controlled by the controller so that the entire amount of product water discharged from the fuel cell stack 90 is supplied to the second heat exchanger 130 of the accumulator 80 (refer to step S2).

Accordingly, in the accumulator 80, the refrigerant receives thermal energy from the product water that has been discharged from the fuel cell stack 90 and then has passed through the interior of the second heat exchanger 130 (heat exchange is performed between the refrigerant and the product water generated by the fuel cell, refer to step S3). Here, the refrigerant can absorb heat from the product water serving as a heat source, thereby increasing the temperature of the refrigerant and refrigerant pressure inside the accumulator.

In this manner, in an embodiment of the present disclosure, the pressure inside the accumulator, which can be one of the low pressure portions of the thermal management system, may be increased, and pressure control in the low pressure portion may be performed through heat absorption of the refrigerant that absorbs the thermal energy of the product water.

The product water that has passed through the second heat exchanger 130 of the accumulator 80 can be discharged to the outside of the vehicle. The gaseous refrigerant in the accumulator 80 can be suctioned into the compressor 10 in a state in which the pressure of the gaseous refrigerant is increased (low pressure to medium pressure) and then can flow along the refrigerant line 1 so as to recirculate the refrigerant circuit. Afterwards, when the heating mode is turned off (refer to step S7), the above-described control process can be completed.

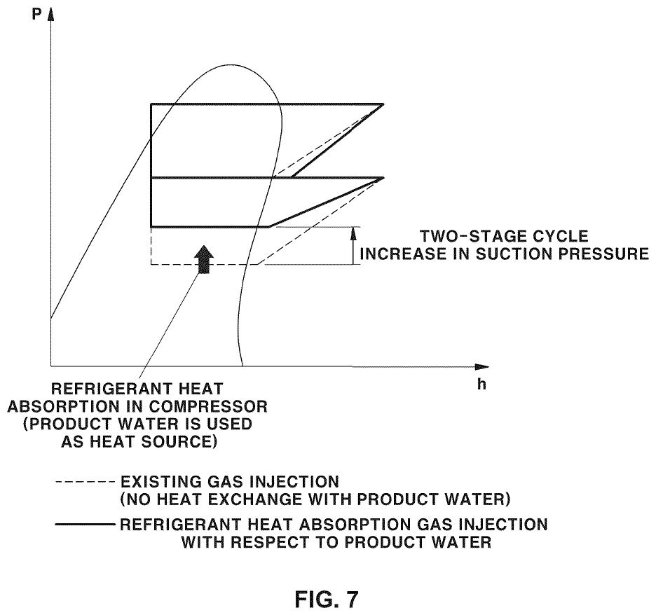

FIG. 7 is a P-H diagram showing an increase in suction pressure of a two-stage cycle in the heating mode of FIG. 6. In FIG. 7, a dotted line represents a conventional gas injection state, and a solid line represents a refrigerant heat absorption gas injection state of an embodiment of the present disclosure.

As described above, as the refrigerant absorbs heat from the product water inside the accumulator 80, the pressure inside the accumulator, which can be a low pressure portion, can increase. Accordingly, as shown in FIG. 7, an effect of increasing the suction pressure (compressor suction pressure) of the two-stage cycle may be obtained.

More specifically, in an embodiment of the present disclosure, the product water generated from the fuel cell stack 90 can be supplied to the accumulator 80 through the flow control valve 110 operating and functioning as a pressure control valve.

The thermal energy of the product water may be supplied to the refrigerant in the accumulator 80, and refrigerant heat absorption may be performed in the accumulator 80 (heat absorption with respect to the heat source in the two-stage cycle). As a result, a system using a two-stage expansion portion efficiently can perform pressure control of a low pressure portion, thereby improving usability of the system.

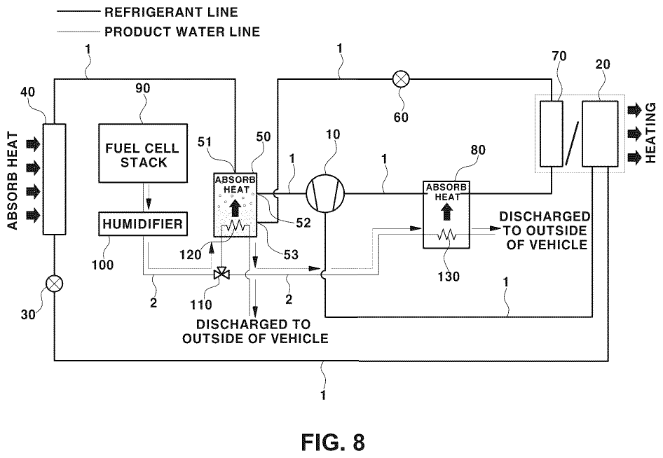

FIG. 8 is a diagram showing another operating state of the thermal management system according to an embodiment of the present disclosure. Specifically, FIG. 8 shows the operating state of a heating mode in which product water generated by a fuel cell is simultaneously supplied to the first heat exchanger 120 of the flash tank 50 and the second heat exchanger 130 of the accumulator 80.

As shown in the drawing, in the case of heating mode in step S1 of FIG. 3, the compressor 10 can be driven (refer to step S2), and gaseous refrigerant inside the flash tank 50 and the accumulator 80 can be suctioned by the compressor 10. Thereafter, the gaseous refrigerant can be compressed to high temperature and high pressure and then discharged. The discharged refrigerant can flow along the refrigerant line 1 and can be supplied to the indoor heat exchanger 20 serving as an internal condenser.

The high-temperature and high-pressure refrigerant supplied to the indoor heat exchanger 20 can exchange heat with air-conditioning air passing through the periphery of the indoor heat exchanger 20 while passing through the interior of the indoor heat exchanger 20. In this case, while heat of the refrigerant is transferred to the air-conditioning air, the refrigerant is condensed, and the air-conditioning air is heated. In this manner, the air-conditioning air heated by the refrigerant is discharged into the vehicle interior, thereby heating the vehicle interior.

The refrigerant that has passed through the indoor heat exchanger 20 can expand to a low-temperature and low-pressure state while passing through the first expansion valve 30 (refer to step S2), and the low-temperature and low-pressure refrigerant expanded by the first expansion valve 30 can be supplied to the outdoor heat exchanger 40.

The low-temperature and low-pressure refrigerant supplied to the outdoor heat exchanger 40 can perform heat exchange by absorbing heat from outside air passing through the periphery of the outdoor heat exchanger 40 while passing through the interior of the outdoor heat exchanger 40. During heat exchange, the heat from the outside air can be transferred to the refrigerant, and the temperature of the refrigerant rises.

The refrigerant that has undergone heat absorption in the outdoor heat exchanger 40 flows along the refrigerant line 1 and can be supplied into the flash tank 50. In this case, the opening state of the flow control valve 110 can be controlled by a controller so that a part of the product water discharged from the fuel cell stack 90 can be supplied to the flash tank 50 (refer to step S2).

As a result, the refrigerant in the flash tank 50 can receive thermal energy from the product water that has been discharged from the fuel cell stack 90 and then has passed through the interior of the first heat exchanger 120 (heat exchange is performed between the refrigerant and the product water generated by the fuel cell, refer to step S3). The refrigerant can absorb heat from the product water serving as a heat source, thereby increasing the temperature of the refrigerant and refrigerant pressure inside the flash tank 50.

In this manner, in an embodiment of the present disclosure, the pressure inside the flash tank, which can be one of the low pressure portions of the heat management system, may be increased, and pressure control in the low pressure portion may be performed through heat absorption of the refrigerant that absorbs the thermal energy of the product water.

The product water that has passed through the first heat exchanger 120 of the flash tank 50 can be discharged to the outside of the vehicle, and the gaseous refrigerant in the flash tank 50 can be suctioned into the compressor 10 through the first outlet 52 in a state in which the pressure of the gaseous refrigerant is increased (low pressure to medium pressure) and then flows along the refrigerant line 1 so as to recirculate the refrigerant circuit.

The liquid refrigerant in the flash tank 50 can be discharged into the refrigerant line 1 through the second outlet 53 and can flow to the second expansion valve 60. After passing through the second expansion valve 60, the liquid refrigerant can flow to the accumulator 80 through the evaporator 70.

Simultaneously, the opening state of the flow control valve 110 can be controlled by the controller so that the remaining product water discharged from the fuel cell stack 90 can be supplied to the second heat exchanger 130 of the accumulator 80 (refer to step S2).

Accordingly, in the accumulator 80, the refrigerant can receive thermal energy from the product water that has been discharged from the fuel cell stack 90 and then has passed through the interior of the second heat exchanger 130 (heat exchange is performed between the refrigerant and the product water generated by the fuel cell, refer to step S3). The refrigerant can absorb heat from the product water serving as a heat source, thereby increasing the temperature of the refrigerant and refrigerant pressure inside the accumulator 80.

In this manner, in an embodiment of the present disclosure, the pressure inside the accumulator, which can be one of the low pressure portions of the thermal management system, may be increased, and pressure control in the low pressure portion may be performed through heat absorption of the refrigerant that absorbs the thermal energy of the product water.

The product water that has passed through the second heat exchanger 130 of the accumulator 80 can be discharged to the outside of the vehicle. The gaseous refrigerant in the accumulator 80 can be suctioned into the compressor 10 in a state in which the pressure of the gaseous refrigerant is increased (low pressure to medium pressure) and then can flow along the refrigerant line 1 so as to recirculate the refrigerant circuit. Afterwards, when the heating mode is turned off (refer to step S7), the above-described control process can be completed.

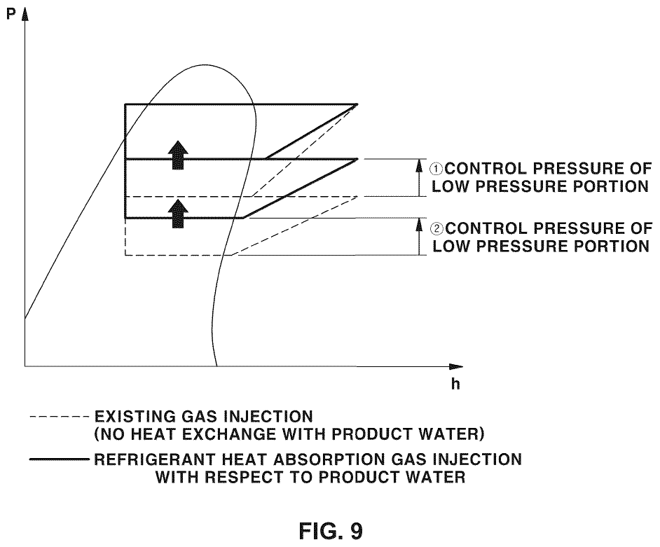

FIG. 9 is a P-H diagram showing the control and rise of suction pressure in the single-stage cycle and the two-stage cycle in the heating mode of FIG. 8. In FIG. 9, a dotted line represents a conventional gas injection state, and a solid line represents a refrigerant heat absorption gas injection state of the present disclosure.

As described above, while heat absorption of the refrigerant with respect to the product water can occur simultaneously in the flash tank 50 and the accumulator 80, the pressure inside the flash tank and the accumulator, which can be low pressure portions, can be increased. Accordingly, an effect of increasing the suction pressure (compressor suction pressure) of the single-stage cycle and the two-stage cycle may be obtained.

More specifically, in an embodiment of the present disclosure, the product water generated from the fuel cell stack 90 can be simultaneously supplied to the flash tank 50 and the accumulator 80 through the flow control valve 110 operating and functioning as a pressure control valve.

In this case, the thermal energy of the product water may be supplied to the refrigerant in the flash tank 50 and the accumulator 80, and refrigerant heat absorption may be performed simultaneously in the flash tank 50 and the accumulator 80. As a result, the pressure of the gaseous refrigerant injected into the compressor 10 after expansion by the first expansion valve 30 and the second expansion valve 60 may be increased.

Particularly, in both the flash tank 50 and the accumulator 80, in an embodiment of the present disclosure, it is possible to perform refrigerant heat absorption in which the refrigerant absorbs the thermal energy of the product water. Because the opening state of the flow control valve 110 can be controlled by the controller, the amount of product water distributed to the first heat exchanger 120 of the flash tank 50 and the second heat exchanger 130 of the accumulator 80 may be adjusted.

In this manner, it possible to control the suction pressure and the refrigerant amount in the low pressure portions of the first stage and the second stage. That is, the pressure of the refrigerant suctioned in the flash tank 50 and the pressure of the refrigerant suctioned in the accumulator 80 may be adjusted by a distribution amount of product water.

As a result, efficiency of the compressor 10 may be improved through this configuration. Further, in an embodiment of the present disclosure, it is possible to control pressure of the low pressure portion depending on the amount of heat exchange in the first stage (flash tank) and the second stage (accumulator), thereby improving utilization and efficiency of the entire gas injection heat pump system.

FIG. 10 is a diagram showing the operating state in the cooling mode of the thermal management system according to an embodiment of the present disclosure. Specifically, FIG. 10 shows the operating state in which product water generated by a fuel cell is supplied to the first heat exchanger 120 of the flash tank 50.

In the thermal management system of the gas injection type, when it is necessary or desired to increase subcooling capacity for condensation of refrigerant and heat dissipation thereof, in an embodiment of the present disclosure, it is possible to perform control to achieve the operating state in FIG. 10.

When a cooling system is operated in the summer, as the refrigerant pressure increases, condensation performance in the outdoor heat exchanger 40 configured to discharge heat from the refrigerant to the outside air may deteriorate. Therefore, an additional heat dissipation means can be required or can boost performance.

In addition to heat dissipation in the outdoor heat exchanger 40, heat exchange between the product water generated by the fuel cell and the refrigerant can be performed in the flash tank 50 for additional heat dissipation. In this case, the flash tank 50 can serve as a water-cooled condenser configured to discharge heat of the refrigerant into the product water generated by the fuel cell.

For this additional heat dissipation, the opening state of the flow control valve 110 can be controlled by a controller so that the product water generated by the fuel cell and discharged from the fuel cell stack 90 may flow into the first heat exchanger 120 of the flash tank 50.

Referring to FIGS. 3 and 10, in the cooling mode in steps S1 and S4 of FIG. 3, the compressor 10 can be driven (refer to step S5), and gaseous refrigerant inside the flash tank 50 and the accumulator 80 can be suctioned by the compressor 10. Then, the gaseous refrigerant can be compressed to high temperature and high pressure and then discharged. The discharged refrigerant can flow along the refrigerant line 1 and can be supplied to the indoor heat exchanger 20 serving as an internal condenser.

The refrigerant supplied thereto in this manner can pass through the indoor heat exchanger 20, flow along the refrigerant line 1, pass through the first expansion valve 30, and then be supplied to the outdoor heat exchanger 40. The first expansion valve 30 may be controlled to be fully opened so as to allow the refrigerant to pass therethrough without causing expansion of the refrigerant to a low-temperature and low-pressure state, or may be controlled to adjust a flow rate of the expanded refrigerant.

Thereafter, the refrigerant supplied to the outdoor heat exchanger 40 can discharge heat to the outside air passing through the periphery of the outdoor heat exchanger while passing through the interior of the outdoor heat exchanger, and the refrigerant that has completely dissipated heat thereof to the outside air in the outdoor heat exchanger 40 can flow along the refrigerant line 1 and be supplied to the flash tank 50.

The controller can control the opening state of the flow control valve 110 so that the product water discharged from the fuel cell stack 90 can pass through the humidifier 100, flow along the product water line 2, and be supplied to the first heat exchanger 120 of the flash tank 50 (refer to step S5).

As a result, while the product water is supplied to the first heat exchanger 120 of the flash tank 50 through the flow control valve 110 and passes through the first heat exchanger, additional heat dissipation of the refrigerant can be performed through heat exchange between the refrigerant and the product water.

After the refrigerant that has discharged heat to the outside air while passing through the outdoor heat exchanger 40 is supplied to the flash tank 50 along the refrigerant line 1, heat exchange can be performed between the refrigerant and the product water passing through the first heat exchanger 120 in the flash tank 50 (heat exchange is performed between the refrigerant and the product water generated by the fuel cell, refer to step S6). Heat of the refrigerant can be transferred to the product water so as to perform additional heat dissipation.

In addition, in the flash tank 50 in which additional heat dissipation of the refrigerant is performed by the product water generated by the fuel cell, the gaseous refrigerant can be suctioned and injected into the compressor 10 through the first outlet 52. Meanwhile, the liquid refrigerant can be discharged into the refrigerant line 1 through the second outlet 53 and then pass through the second expansion valve 60. Additionally, for additional heat dissipation, the product water that has passed through the first heat exchanger 120 of the flash tank 50 can be discharged to the outside of the vehicle.

The refrigerant can expand to a low-temperature and low-pressure state while passing through the second expansion valve 60 (refer to step S5), and then the low-temperature and low-pressure refrigerant can be supplied to the evaporator 70 along the refrigerant line 1. Thereafter, while the refrigerant passes through the interior of the evaporator 70, heat exchange can be performed between the refrigerant and air-conditioning air passing through the periphery of the evaporator 70.

In this case, the air-conditioning air can be cooled by the low-temperature refrigerant in the evaporator 70, and the air-conditioning air cooled by the heat exchange with the refrigerant can be discharged into the vehicle interior, thereby cooling the vehicle interior. The refrigerant that has passed through the evaporator 70 then can flow to the accumulator 80 along the refrigerant line 1. Thereafter, the refrigerant can be suctioned and injected again from the accumulator 80 into the compressor 10 so as to recirculate the refrigerant circuit.

In this manner, the high-temperature and high-pressure refrigerant compressed by the compressor 10 can pass through the first heat exchanger 120, and simultaneously, the low-temperature and low-pressure refrigerant expanded by the second expansion valve 60 can pass through the evaporator 70.

However, in the cooling mode, the position of a door can be controlled by the controller so that, while air-conditioning air supplied by an air-conditioning blower passes through an air passage of an air-conditioning case, the air-conditioning air does not pass through the indoor heat exchanger 20 but only passes through the evaporator 70.

Meanwhile, FIGS. 4, 6, and 8 are diagrams each showing the operating state in the heating mode. Specifically, in FIGS. 4, 6, and 8, basically, the high-temperature and high-pressure refrigerant compressed by the compressor 10 exchanges heat with the air-conditioning air while passing through the indoor heat exchanger 20, and the air-conditioning air heated by the refrigerant is discharged into the vehicle interior, thereby heating the vehicle interior.

The air-conditioning air can be supplied by the air-conditioning blower, and the position of the door can be controlled by the controller so that, in the heating mode, while the air supplied by the air-conditioning blower passes through the air passage of the air-conditioning case, the air only passes through the indoor heat exchanger 20 without passing through the evaporator 70.

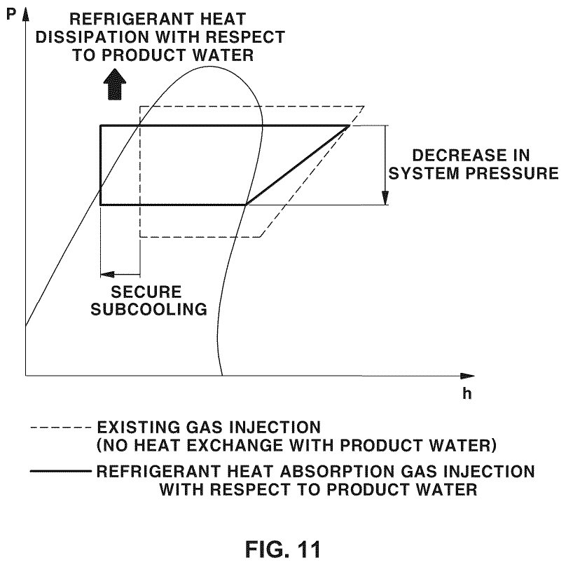

FIG. 11 is a P-H diagram showing a decrease in system pressure in the cooling mode of FIG. 10. Specifically, in FIG. 11, additional heat dissipation of the refrigerant can be performed by heat exchange between the refrigerant and the product water in the flash tank 50, and additional subcooling can be secured, thereby increasing the amount of liquid refrigerant for cooling and lowering the pressure of the system.

As can be apparent from the above description, in a thermal management system for a fuel cell vehicle and a control method thereof according to an embodiment of the present disclosure, a flow control valve can be controlled so as to adjust a flow path of product water generated by a fuel cell and pressure thereof, and refrigerant can absorb heat from the product water generated by the fuel cell in a flash tank and/or an accumulator, thereby making it possible to control the pressure of a low pressure portion.

In this manner, in an embodiment of the present disclosure, it can be possible not only to secure performance of a gas injection heat pump in a low temperature region (achieving a boosting effect), but also to control and improve system efficiency through pressure control of the low pressure portion of the thermal management system.

The present disclosure has been described in detail with reference to example embodiments. However, it can be appreciated by those skilled in the art that changes may be made in these example embodiments without departing from the principles and spirit of the present disclosure, the scopes of which can be defined in the appended claims and equivalents thereto.

What is claimed is:

1. A thermal management system for a fuel cell vehicle, the thermal management system comprising:
a compressor configured to compress refrigerant;
a refrigerant-water heat exchanger provided to enable the compressor to suction the refrigerant therein, wherein the refrigerant-water heat exchanger has a first heat exchanger provided therein and configured to perform heat exchange between the refrigerant and product water generated by a fuel cell and discharged from a fuel cell stack;
an accumulator provided to enable the compressor to suction the refrigerant therein, wherein the accumulator has a second heat exchanger provided therein and configured to perform heat exchange between the refrigerant and the product water generated by the fuel cell;
a flow control valve installed on a product water line configured to supply the product water, wherein the flow control valve controls an opening state thereof so as to selectively supply the product water to one of the first heat exchanger or the second heat exchanger, or to both of the first heat exchanger and the second heat exchanger; and
a controller configured to control the opening state of the flow control valve.

2. The system of claim 1, further comprising an outdoor heat exchanger configured to perform heat exchange between the refrigerant and air, wherein the first heat exchanger is configured to perform the heat exchange between the refrigerant passing through the outdoor heat exchanger and the product water generated by the fuel cell.

3. The system of claim 2, further comprising:
an indoor heat exchanger configured to perform heat exchange between the refrigerant compressed by the compressor and air-conditioning air;
a first expansion valve configured to selectively expand the refrigerant passing through the indoor heat exchanger so as to supply the refrigerant to the outdoor heat exchanger;
a second expansion valve configured to expand the refrigerant discharged from the refrigerant-water heat exchanger; and
an evaporator configured to perform heat exchange between the refrigerant passing through the second expansion valve and the air-conditioning air, wherein the second heat exchanger is configured to perform the heat exchange between the refrigerant passing through the evaporator and the product water generated by the fuel cell.

4. The system of claim 1, wherein the controller is configured to control, in a heating mode, the opening state of the flow control valve, thereby supplying the product water generated by the fuel cell to the first heat exchanger of the refrigerant-water heat exchanger and performing the heat exchange between the refrigerant in the refrigerant-water heat exchanger and the product water generated by the fuel cell.

5. The system of claim 1, wherein the controller is configured to control, in a heating mode, the opening state of the flow control valve, thereby supplying the product water generated by the fuel cell to the second heat exchanger of the accumulator and performing the heat exchange between the refrigerant in the accumulator and the product water generated by the fuel cell.

6. The system of claim 1, wherein the controller is configured to control, in a heating mode, the opening state of the flow control valve, thereby simultaneously supplying and distributing the product water generated by the fuel cell to the first heat exchanger of the refrigerant-water heat exchanger and the second heat exchanger of the accumulator and performing the heat exchange between the refrigerant in the refrigerant-water heat exchanger and the accumulator and the product water generated by the fuel cell.

7. The system of claim 1, wherein the controller is configured to control, in a cooling mode, the opening state of the flow control valve, thereby supplying the product water generated by the fuel cell to the first heat exchanger of the refrigerant-water heat exchanger and performing the heat exchange between the refrigerant in the refrigerant-water heat exchanger and the product water generated by the fuel cell.

8. The system of claim 1, wherein the product water line branches into two branch lines respectively connected to the first heat exchanger and the second heat exchanger, and
wherein the flow control valve is installed at a location at which the product water line branches into the two branch lines.

9. The system of claim 1, wherein the refrigerant-water heat exchanger is a flash tank configured to separate gaseous refrigerant from liquid refrigerant therein, wherein the flash tank is configured to supply the gaseous refrigerant to the compressor and to supply the liquid refrigerant to an expansion valve.

10. A control method for a thermal management system of a fuel cell vehicle, the control method comprising:
performing heat exchange, in a first heat exchanger, between a refrigerant and product water generated by a fuel cell and discharged from a fuel cell stack, wherein the first heat exchanger is located within a refrigerant-water heat exchanger, wherein the refrigerant-water heat exchanger is provided to enable a compressor to suction the refrigerant therein;
performing heat exchange, in a second heat exchanger, between the refrigerant and the product water generated by the fuel cell, wherein the second heat exchanger is located within an accumulator, wherein the accumulator is configured to store the refrigerant passing through an evaporator and to enable the compressor to suction the refrigerant stored therein; and
supplying the product water generated by the fuel cell and discharged from the fuel cell stack using a flow control valve installed on a product water line, wherein the flow control valve controls an opening state thereof so as to selectively supply the product water generated by the fuel cell to one of the first heat exchanger or the second heat exchanger, or to both of the first heat exchanger and the second heat exchanger, wherein the opening state of the flow control valve is controlled depending on a cooling mode and a heating mode by a controller, thereby selectively supplying the product water generated by the fuel cell to one of the first heat exchanger or the second heat exchanger, or to both of the first heat exchanger and the second heat exchanger.

11. The method of claim 10, further comprising:
performing heat exchange, by an outdoor heat exchanger, between the refrigerant and air; and
performing the heat exchange, by the first heat exchanger, between the refrigerant passing through the outdoor heat exchanger and the product water generated by the fuel cell.

12. The method of claim 11, further comprising:
performing heat exchange, by an indoor heat exchanger, between the refrigerant compressed by the compressor and air-conditioning air;
selectively expanding, by a first expansion valve, the refrigerant passing through the indoor heat exchanger so as to supply the refrigerant to the outdoor heat exchanger;
expanding, by a second expansion valve, the refrigerant discharged from the refrigerant-water heat exchanger;
performing heat exchange, by the evaporator, between the refrigerant passing through the second expansion valve and the air-conditioning air; and
performing the heat exchange, by the second heat exchanger, between the refrigerant passing through the evaporator and the product water generated by the fuel cell.

13. The method of claim 10, further comprising, in the heating mode, controlling, by a controller, the opening state of the flow control valve, thereby supplying the product water generated by the fuel cell to the first heat exchanger of the refrigerant-water heat exchanger and performing the heat exchange between the refrigerant in the refrigerant-water heat exchanger and the product water generated by the fuel cell.

14. The method of claim 10, further comprising, in the heating mode, controlling, by a controller, the opening state of the flow control valve, thereby supplying the product water generated by the fuel cell to the second heat exchanger of the accumulator and performing the heat exchange between the refrigerant in the accumulator and the product water generated by the fuel cell.

15. The method of claim 10, further comprising, in the heating mode, controlling, by a controller, the opening state of the flow control valve, thereby simultaneously supplying and distributing the product water generated by the fuel cell to the first heat exchanger of the refrigerant-water heat exchanger and the second heat exchanger of the accumulator and performing the heat exchange between the refrigerant in the refrigerant-water heat exchanger and the accumulator and the product water generated by the fuel cell.

16. The method of claim 10, further comprising, in the cooling mode, controlling, by a controller, the opening state of the flow control valve, thereby supplying the product water generated by the fuel cell to the first heat exchanger of the refrigerant-water heat exchanger and performing the heat exchange between the refrigerant in the refrigerant-water heat exchanger and the product water generated by the fuel cell.

17. The method of claim 10, wherein the product water line in the thermal management system branches into two branch lines respectively connected to the first heat exchanger and the second heat exchanger, and wherein the flow control valve in the thermal management system is installed at a location at which the product water line branches into the two branch lines.

18. The method of claim 10, wherein the refrigerant-water heat exchanger in the thermal management system is a flash tank, and further comprising:
separating, by the flash tank, gaseous refrigerant from liquid refrigerant therein;
supplying, by the flash tank, the gaseous refrigerant to the compressor; and
supplying, by the flash tank, the liquid refrigerant to an expansion valve.

19. A thermal management system for a fuel cell vehicle, the thermal management system comprising:
a refrigerant-water heat exchanger having a first heat exchanger provided therein, wherein the first heat exchanger is configured to perform heat exchange between a refrigerant in a refrigerant line and a product water generated by a fuel cell and discharged from a fuel cell stack in a product water line, wherein the refrigerant line and the product water line extend through the first heat exchanger within the refrigerant-water heat exchanger; and
an accumulator having a second heat exchanger provided therein, wherein the second heat exchanger is configured to perform heat exchange between the refrigerant in the refrigerant line and the product water generated by the fuel cell in the product water line, wherein the refrigerant line and the product water line extend through the second heat exchanger within the accumulator.

20. The system of claim 19, further comprising:
a compressor configured to compress the refrigerant in the refrigerant line, wherein the refrigerant line connects to the compressor, wherein the refrigerant-water heat exchanger is configured to enable the compressor to suction the refrigerant therein, and wherein the accumulator is configured to enable the compressor to suction the refrigerant therein;
a flow control valve installed on the product water line configured to supply the product water discharged from the fuel cell stack of the fuel cell, wherein the flow control valve controls an opening state thereof so as to selectively supply the product water to one of the first heat exchanger or the second heat exchanger, or to both of the first heat exchanger and the second heat exchanger; and
a controller configured to control the opening state of the flow control valve.
